(19) United States
(12) Patent Application Publication
(10) Pub. No.: US 2015/0241389 A1
(43) Pub. Date: Aug. 27, 2015

(54) MULTI-CAPILLARY CARTRIDGE FOR CAPILLARY ELECTROPHORESIS

(71) Applicant: PROTEINSIMPLE, Santa Clara, CA (US)

(72) Inventor: Kevin Hill, Santa Clara, CA (US)

(73) Assignee: PROTEINSIMPLE, Santa Clara, CA (US)

(21) Appl. No.: 14/188,053

(22) Filed: Feb. 24, 2014

(51) Int. Cl. G01N 27/447; B32B 37/12; B32B 37/18; B32B 41/00

(52) U.S. Cl. CPC G01N 27/44795; G01N 27/44791; B32B 41/00; B32B 37/1284; B32B 37/18

(57) ABSTRACT

Some embodiments described herein relate to a capillary cartridge. A capillary cartridge can include a multiple of capillaries configured to be used for capillary electrophoresis. The capillaries can be fixed relative to each other in at least a radial direction by a capillary spacer plate. A slit plate can be coupled to the capillary spacer plate and can define optical access to the capillaries such that optical measurements, such as absorbance or fluorescence measurements can be made while the capillaries are within the cartridge.

### BACKGROUND

Some embodiments described herein relate to a multi-capillary cartridge intended for use for capillary electrophoresis. Some embodiments described herein relate to a method for assembling a multi-capillary cartridge. Some embodiments described herein relate to an automated capillary electrophoresis assay system configured to use multi-capillary cartridges.

A number of methods and systems have been developed for conducting various processing and/or analyses of biological substances, such as those described in U.S. Pat. No. 6,423,536 for temperature cycling processes, U.S. Pat. Nos. 5,843,680, 5,784,154, 5,395,502, and 5,137,609 for separation assay methods, U.S. Pat. No. 5,785,926 for a capillary transport system, international publication WO94/13829 for an isoelectric focusing separation assay system, and U.S. Pat. No. 6,430,512 for a chromatographic fluorescence separation and display system. Each of these is incorporated herein by reference in its entirety.

U.S. patent application Ser. No. 60/589,139, filed Jul. 19, 2004 and entitled “Continuous Determination of Cellular Contents by Chemiluminescence,” U.S. patent application Ser. No. 60/617,362, filed Oct. 8, 2004 and entitled “Determination of Captured Cellular Contents,” and U.S. patent application Ser. No. 11/185,247, filed Jul. 19, 2005 and entitled “Methods and Devices for Analyte Detection,” and U.S. patent application Ser. No. 10/139,100 entitled Microfluidic Device for Analyzing Nucleic Acids and/or Proteins, Methods of Preparation and Uses Thereof,” the disclosures of each of which is incorporated herein by reference in their entirety, all describe apparatus and methods for assaying microliter volumes of cellular material by separating constituent substances of the material in a fluid chamber such as a capillary, binding the separated substances in place, then eliciting an optical response from the bound substances such as fluorescence or chemiluminescence. The resulting information has content similar to that of a Western gel blot but without the complex, extensive and time-consuming handling and processing steps that adversely affect reproducibility and make automation difficult.

U.S. patent application Ser. No. 13/778,757, filed Feb. 27, 2013 entitled “Automated Micro-volume Assay System,” the disclosure of which is incorporated herein by reference in its entirety, describes an automated assay system that separates constituent substances of a sample within capillaries. Known automated systems, however, convey individual capillary tubes from a staging area to a test cell. Because of their size and fragility, manipulating individual capillary tubes raises potential automation challenges, and, as a result, such automation may be relatively complex. A need therefore exists for a cartridge including multiple capillary tubes suitable for use in automated assay systems, methods for assembling such cartridges, and assay systems configured to use such cartridges.

### SUMMARY

Some embodiments described herein relate to a capillary cartridge. A capillary cartridge can include multiple capillaries configured to be used for capillary electrophoresis. The capillaries can be fixed relative to each other in at least a radial direction by a capillary spacer plate. A slit plate can be coupled to the capillary spacer plate and can define optical access to the capillaries such that optical measurements, such as absorbance or fluorescence measurements can be made while the capillaries are within the cartridge.

### BRIEF DESCRIPTION OF THE FIGURES

FIG. 1 is a front perspective view of a capillary electrophoresis analyzer, according to an embodiment.

FIGS. 2A-2D illustrate capillary holders, according to various embodiments.

FIG. 3 is an exploded isometric view of a multi-capillary cartridge, according to an embodiment.

FIG. 4 is a detail view of a portion of a capillary spacer plate of FIG. 3, according to an embodiment.

FIG. 5 is an exploded isometric view of a jig for assembling a capillary cartridge, according to an embodiment.

FIG. 6 is a flow chart of a method for assembling a capillary cartridge, according to an embodiment.

### DETAILED DESCRIPTION

Some embodiments described herein relate to a capillary cartridge. A capillary cartridge can include multiple capillaries configured to be used for capillary electrophoresis. The capillaries can be fixed relative to each other in at least a radial direction by a capillary spacer plate. A slit plate can be coupled to the capillary spacer plate and can define optical access to the capillaries such that optical measurements, such as absorbance or fluorescence measurements, can be made while the capillaries are within the cartridge.

Some embodiments described herein relate to a method of assembling a capillary cartridge. Assembling a capillary cartridge can include placing multiple capillaries into receiving portions of a capillary spacer plate such that the capillaries can be fixed relative to each other in at least a radial direction. A slit plate can be coupled to the capillary spacer plate. The spit plate can define one or more openings operable to provide optical access to one or more capillaries. In this way, once assembled, the cartridge can be moved to an electrophoretic cell and optical measurements can be made of the capillaries without removing the capillaries from the cartridge.

Some embodiments described herein relate to a system including a capillary electrophoresis analyzer and a capillary cartridge. The capillary electrophoresis analyzer can include a capillary holder operable to receive the capillary cartridge. The capillary cartridge can include multiple capillaries where the position of each capillary is fixed in at least one dimension relative to each other capillary. Furthermore, the capillary cartridge can define optical pathways. An optical pathway can include a portion of a capillary such that an optical measurement can be made of the capillary without removing the capillary from the capillary cartridge.

A multi-capillary cartridge can be used in any suitable electrophoretic application, such as on-line and real-time measurement of capillary electrophoresis. For example, a multi-capillary cartridge can be used in connection with the methods and processes described in U.S. Pat. No. 5,985,121, entitled “Fast Sampling Device and Sample Sampling Method for Capillary Electrophoresis,” the disclosure of which is incorporated herein by reference in its entirety.

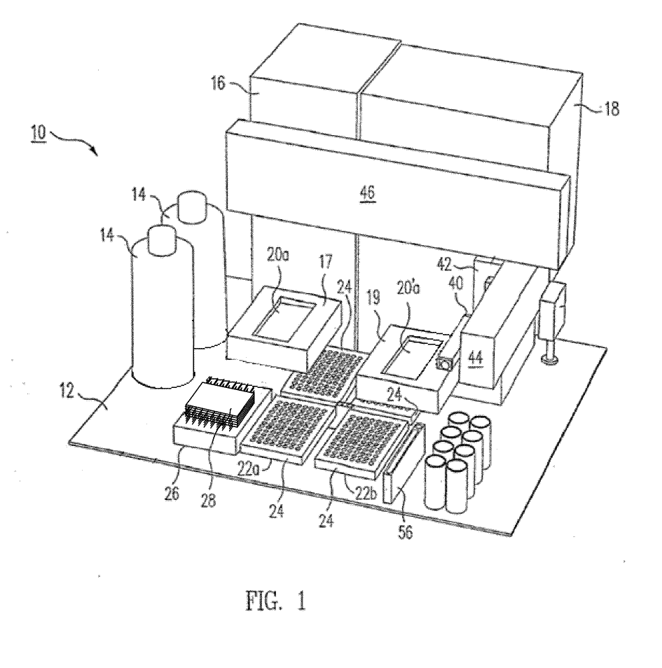

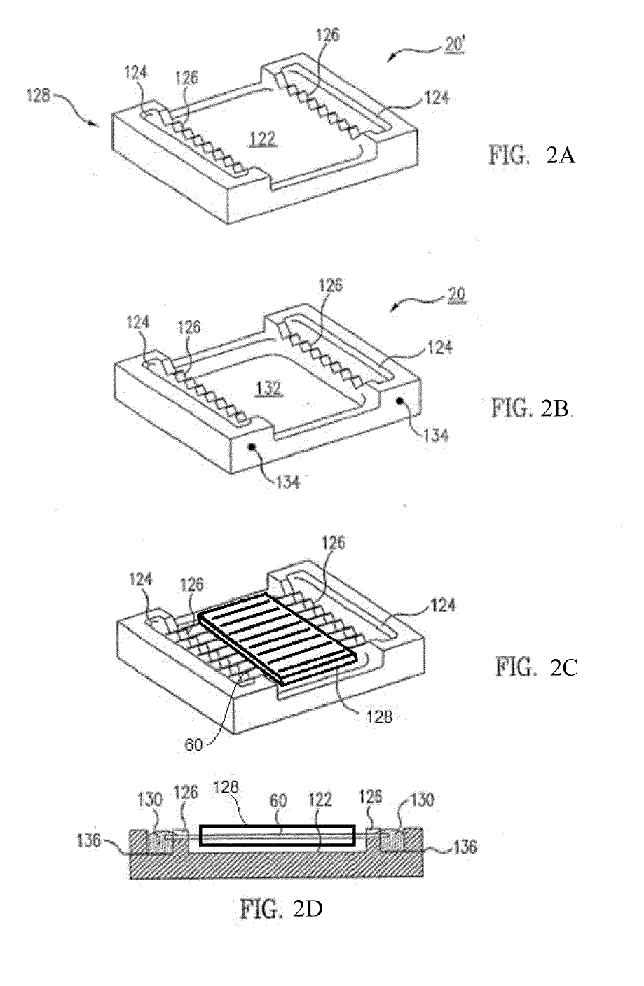

A capillary electrophoresis analyzer is shown in FIG. 1. In some embodiments, an analyzer 10 is mounted on a baseplate 12 with a surface suitable for wipe down if biohazardous materials are processed though the system (e.g., stainless steel or plastic). Shown on the baseplate 12 are a pair of bottles 14 which contain bulk fluids. Clean wash fluid is pumped for use from one bottle while all system waste fluids are pumped into the other bottle. Toward the back of the baseplate 12 is a detection module 16. The detection module 16 houses a movable tray 17 with a space 20a for a capillary holder (such as the capillary holders shown in FIGS. 2A-2D). The movable tray 17 is automated to slide into and out from the detection module 16 to transport the capillary holders into and out of the detection module 16. The detection module 16 houses an imaging optical detector for detecting light emitted from within and/or through the capillaries. In this embodiment the optical detector is a cooled charge-coupled device (CCD) array detector. Light from capillaries is imaged onto the CCD by a lens assembly. The detection module 16 is light-tight when the tray 17 is retracted to the interior of the module, enabling the CCD array detector to detect light emitted from a capillary by chemiluminescence or fluorescence. To excite fluorescence an array of light emitting diodes inside the detection module 16 is arranged to uniformly illuminate the capillaries. Alternatively, a laser or other light source could be used for excitation. Wavelength-selective filters are used to prevent excitation light, emitted from the light emitting diodes, from interfering with detection of the fluorescent emissions. For chemiluminescent detection, a material such as luminol is flowed through the capillaries by hydrodynamic flow as described below and the emitted photons are detected by the CCD array detector. In an alternative embodiment luminol may be electrically pumped through the capillaries by application of voltage across the capillaries with hardware similar to that described below. During detection, a capillary cartridge 28 containing the capillaries is held in a capillary holder on the tray 17, which is retracted into the detection module 16 and moves out again after photodetection is completed. The detection process may take from seconds to hours depending on the level of sensitivity desired.

As referred to herein, the term capillary or capillaries is meant to include any device that has one or more internal tubes or bores with a small dimension. The internal tube(s) can have any suitable shape, and for example may be circular, square, triangular, and the like. The term capillary or capillaries include multiple internal tubes, and for example include microfabricated devices that contain internal channels as the tubes. Generally, the internal tube(s) have any suitable dimension. In some embodiments the dimension of the internal tube(s) is in the range of 1 micron to 2000 microns. In other embodiments, the dimension of the internal tube(s) is in the range of 25 microns to 250 microns. In some embodiment, the length of the internal tube(s) is in the range of 30 mm to 100 mm. The external size and shape of the capillaries are not limited.

Capillary holders are described in greater detail in FIGS. 2A-2D. The capillary holder is operable to hold a plurality of individual capillaries and/or a capillary cartridge 28 containing multiple capillaries. In this way, multiple capillaries can be moved into the detection module 16 such that the CCD array will detect photoemissions from a plurality of capillaries at the same time. In some embodiments a scanning fluorescence detector may be used. In such an embodiment, excitation light focused by a lens irradiates fluorescent molecules within each capillary. This same (or another) lens collects the resulting fluorescent emission for detection by a photo-sensitive device such as a photo-multiplier tube. This focused excitation/collection can be scanned along the length of each capillary individually or in groups. The excitation light is a coherent source such as a laser or an incoherent source such as an arc lamp or light emitting diode array.

Adjacent to the detection module 16 is a processing station 18. In some embodiments, the processing station 18 performs either separation and/or capture. In other embodiments, the processing station 18 can perform separation, capture and detection. As described below in some embodiments, the capillary holder has two integrated electrodes that are electrically connected to respective fluid reservoirs on opposite sides of the capillary holder. The ends of the capillaries (see FIG. 2C) in the capillary holder are in fluidic contact with the fluids in these two reservoirs. Thus, when the separation module 18 applies a voltage across the electrodes, this voltage is applied across the fluid paths within the capillaries in the capillary holder. The voltage applied to the capillaries is regulated by a computer controlled power supply (not shown) located inside or coupled to the module 18. This voltage causes the biological molecules to separate by isoelectric focusing. In some embodiments the molecules may be separated by size or other techniques.

Located on the baseplate 12 are a number of microwell plate stations 22a-22d. FIG. 1 shows a microwell plate 24 located in each of the stations 22a-22d. In some embodiments, the microwell plate(s) containing samples are chilled while in these stations. This may be accomplished preferably by thermoelectric cooling or by other means such as refrigeration, recirculating cold fluid or an ice bath coupled to the sample plates. The stations have guides or recesses that precisely define the locations of standard microwell plates when located in the stations. Each microwell plate station in this embodiment is marked on the baseplate 12 by a distinguishing color or graphic visible through a translucent microwell plate, enabling each station to be distinctively identified. A standard microwell plate may contain 96 microwells on a 9 mm center-to-center spacing or 384 microwells on a 4.5 mm center-to-center spacing. Plates with other spacings and numbers of wells may be used and the invention is not intended to be limited to any one specific configuration.

In some embodiments, a robotic, computer-controlled manipulator 40 as described herein accesses a preselected well in a microwell plate 24, the plates and each of their wells being in specific, predefined positions on stations 22a-22d. Computer control enables the specification of the microwell plate to be chosen from several predetermined standards to which the manipulator 40 is programmed. Also located on the baseplate 12 is a capillary cartridge station 26. As in the case of the microwell plate stations, the capillary cartridge station 26 locates capillary cartridges 28 in predetermined locations so that capillary cartridges 28 can be automatically accessed by the robotic computer-controlled manipulator 40. A capillary cartridge 28 may contain 4, 6 or 8 capillaries or any other suitable number of capillaries. If the capillaries utilize an internal wall coating for immobilization, they may be supplied precoated in the cartridges 28.

Capillaries are preferably made from a transparent low fluorescence material such as glass that is also rigid and straight. Various inside diameters (typically 10 μm to 1 mm) and lengths (typically 30 mm to 100 mm) are commonly used. In some embodiments, a capillary cartridge 28 includes capillaries that are 40 mm in length with an internal diameter of 100 μm, giving the capillary a volume of 314 microliters. Various cross sectional shapes, both inside and outside, are also possible. Different materials, such as a variety of polymers, can be used for the capillaries. The invention is not limited by the type or configuration of any one type of capillary and any suitable capillary may be employed.

In some embodiments a microfabricated device may be used in place of individual capillaries or a combination thereof. In some embodiments microfabricated devices are fabricated with internal capillary channels whose dimensions would be similar to those described previously for capillaries. A microfabricated device can be fabricated from various materials such as silicon, glass or plastic and may contain integrated electrodes, electronics and valves. They may be disposable or re-usable devices. Microfabricated devices can contain from one to hundreds of channels that can be controllable individually or in parallel or some combination thereof. A typical microfabricated device contains wells for adding samples or other reagents. External electrodes may also be inserted into these wells. As with capillaries, the cross section of a capillary channel is not constrained to any particular shape.

In some embodiments a capillary cartridge 28 can be removed from a capillary cartridge station 26 by a robotic, computer-controlled manipulator 40 comprising a capillary cartridge gripper mounted on robotic actuators 42, 44 and 46. In one embodiment the robotic actuators 42, 44, 46 are motorized linear translation stages and are arranged to provide x, y, z motion control although other actuator mechanisms could also be employed as long as they are computer controllable. The computer-controlled manipulator 40 can move up and down by operation of the up-down actuator 42. The actuator 42 is moved from front to back by actuator 44. Actuator 44 in turn is moved between the left and right sides of the system 10 by and in relation to actuator 46. The computer-controlled manipulator 40 can be hinged at its connection to the actuator 42 by a hinge 48 so that it can be controllably pivoted 90°, thereby allowing the computer-controlled manipulator 40 to move a capillary cartridge 28 from a horizontal to a vertical orientation or vice versa. The combined actuator mechanisms thus can traverse all of the elements of the system in front of the detection and separation and immobilization modules.

FIGS. 2A-2D illustrate various embodiments of a capillary holder. The capillary holder 20′ of FIG. 2A is preferably made of a non-wetting material such as Teflon® or a rubber-like material to take advantage of fluid surface tension. On opposite ends of the capillary holder 20′ are fluid reservoirs 124. In some embodiments, these fluid reservoirs 124 extend continuously for the length of the holder. It is alternatively possible to subdivide the reservoirs 124 into separate compartments so that different capillaries in the holder can be isolated from one another. This would enable individual control or monitoring of each capillary as well as the ability to utilize different fluids for each capillary. The central area 122 of the holder 20′ is recessed so that capillaries and/or capillary cartridges (e.g., the capillary cartridges 28 as shown and described with reference to FIG. 1) may be gripped and deposited and removed from the holder. Similarly stated, the holder 20′ provides access points for gripping the cartridge 128. The inner walls of the reservoirs 124 are formed on one side as a series of V-grooves 126 which retain capillaries. The series of V-grooves 126 are deep enough that when an end of a capillary is deposited into the V-groove it will drop into a position defined by the V-groove 126. The back surface of the capillary holder 20′ (not visible in this illustration) has two electrodes 134 extending from the back side of the holder, each of which protrudes through the wall of the holder and into a reservoir 124. These electrodes are used to apply a potential through the fluid in the capillaries for electrophoresis and isoelectric focusing. Capillary holders may be removed from the system for cleaning if required.

FIG. 2B shows one embodiment of a capillary holder 20. In this embodiment, instead of a central recessed area, the central area 132 of the holder 20 is open. This opening 132 allows the holder to be placed over a CCD detector to acquire photons emitted from substances inside the capillaries. With the embodiment 20′ of FIG. 2A the capillaries are opposed to a CCD detector located above the capillaries. With the embodiment of FIG. 2B the CCD detector can approach the capillaries from either above or below. Placing the CCD above the capillary holder has the advantages of enabling visualization of substantially the full length of capillary and eliminating the possibility of any liquid spilling onto the CCD or imaging optics. In the view of FIG. 2B the electrodes 134 extending from each reservoir 124 can be seen on the front side of the capillary holder.

FIG. 2C shows the capillary holder 20′ with a capillary cartridge 128 having eight capillaries 60. The capillaries 60 are located in the V-grooves.

FIG. 2D is a view of a cross section of a capillary holder of the preceding embodiments. Electrodes 136 extend to and through the lateral sidewalls of the reservoirs 124. The reservoirs 124 are shown filled with a fluid 130. The fluid 130 in each reservoir is seen to be higher than the lowest point in the V-grooves 126 where the capillary 60 is supported. When the capillary is placed in the V-groove 126 it breaks through the surface tension of the fluid 130 in each reservoir, which completely immerses the aperture at each end of the capillary 60 in fluid. Because of the non-wetting material of the holder and capillary 60, however, the surface tension of the fluid 130 is not disturbed to a degree that would cause the fluid to leak into the central area 122 of the capillary holder. The fluid path of the capillary 60 remains in fluidic contact with the fluid 130 in each reservoir (and therefore with the electrodes 136) without any need for a physical seal by virtue of the surface tension of the fluid 130. This is particularly advantageous since there are no moving parts to wear out and making temporary seals to multiple small capillaries can be complicated and expensive to implement. In addition, this approach is significantly more scalable. For continuous chemiluminescent detection as described above, the height of the luminol fluid in one reservoir is higher than the fluid level in the other reservoir, enabling the luminol to flow through the capillary 60 from one reservoir to the other by hydrodynamic flow.

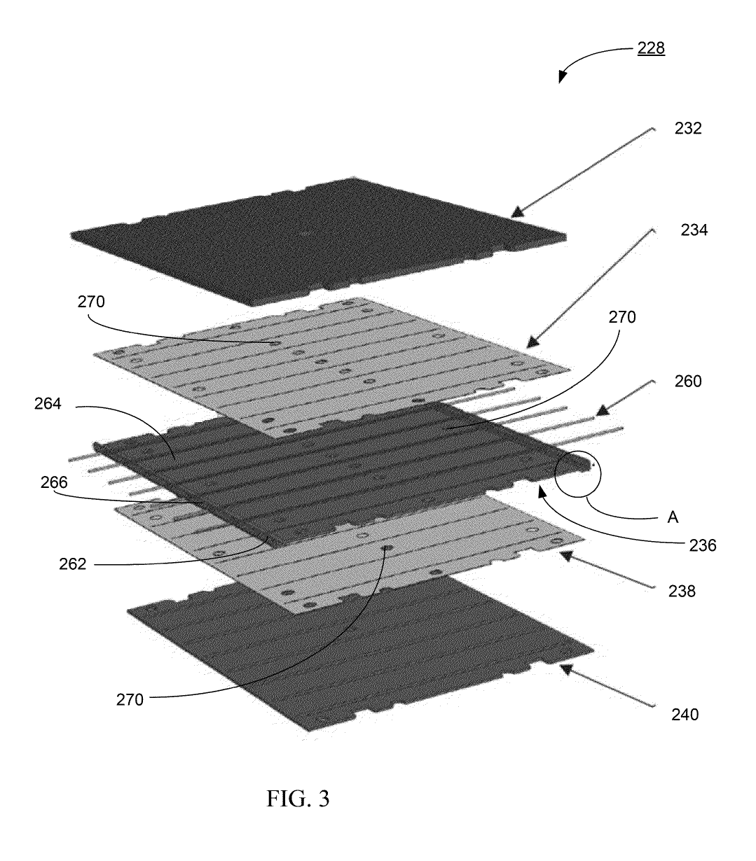

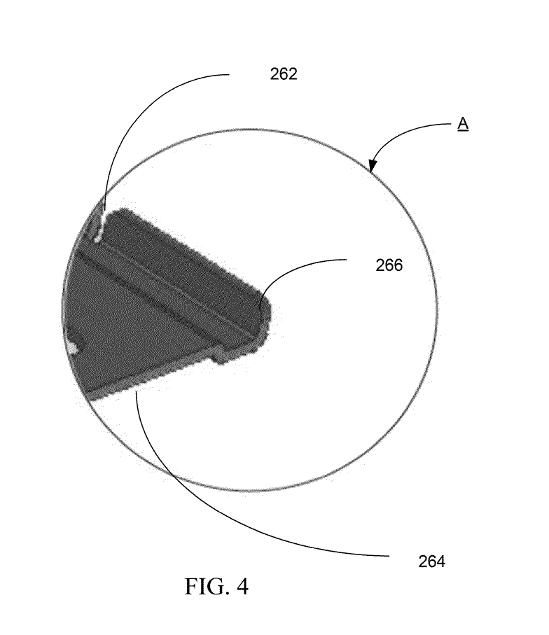

FIG. 3 is an exploded view of a capillary cartridge 228, according to an embodiment. FIG. 4 is a detail view of portion A of the capillary cartridge 228. The capillary cartridge 228 includes a top structural plate 232, a slit plate 234, multiple capillaries 260, a spacer plate 236, a retention plate 238, and a bottom structural plate 240. When the capillary cartridge 228 is assembled, capillaries 260 can be positioned within the spacer plate 260 and/or between the slit plate 234 and the retention plate 238. The retention plate 236 can be coupled to the spacer plate 236 opposite the slit plate 234. The top structural plate 232 and the bottom structural plate 240 can be coupled on opposite sides of the spacer plate 260.

The capillary cartridge 228 can be structurally and/or functionally similar to the capillary cartridges 28 and/or 128 as shown and described with reference to FIGS. 1, 2c, and 2d. For example, the capillary cartridge 228 can be configured to be placed in a capillary holder 20 and/or 20′. The spacer plate 236 has a substantially flat central portion 264, and two edge portions 266. The capillaries 260 can be positioned within the spacer plate 236. For example, the edge portions 266 define capillary receiving portions 262 operable to locate the capillaries 260.

The capillary receiving portions 262 are dimensioned such that the capillaries 260 are accurately positioned within the capillary cartridge 228. For example, the capillary receiving portions 262 can be grooves having a thickness, width, and/or diameter similar to the diameter of the capillaries 260 (e.g., within 5%, within 1%, etc.). In this way movement of the capillaries 260 can be limited when the capillaries 260 are positioned within the spacer plate 236. Furthermore, the capillary receiving portions 262 can be operable to locate the capillaries 260 relative to the slit plate. For example, when the cartridge 228 is assembled, the center of slits of the slit plate 234 can aligned to the center of the capillaries within 10%, 5%, 1%, etc. of the diameter of the capillaries 260 when the slit plate 234 is positioned above the spacer plate 236. Similarly, when the slit plate 234 is positioned above the spacer plate 236, the capillaries 260 and the slits of the slit plate 234 can have a parallelism tolerance less than the diameter of the capillaries 260, less than 25% of the diameter of the capillaries 260, less than 5% of the diameter of the capillaries 260, etc. Similarly stated, spacer plate 236 and the slit plate 234 can collectively be configured such that the slits of the slit plate 234 are closely aligned with the capillaries 260.

As shown, the spacer plate 236 has sixteen capillary receiving portions 262, eight on each edge portion 266. Thus the spacer plate 236 is operable to locate eight capillaries 260 (seven capillaries 260 are shown in FIG. 3). Similarly stated, one end portion of each capillary 260 can be disposed within a capillary receiving portion 262 on one edge portion 266, while a second end portion of each capillary 260 can be disposed within a capillary receiving portion 262 on the other end portion 266. Once the capillaries 260 are disposed within the capillary receiving portions 262, their ability to move in a radial direction (e.g., parallel to the central portion 264) can be constrained.

The edge portions 266 can be orthogonal to the central portion 264 of the spacer plate. In this way, the spacer plate 236 can have depth, which can be similar to the diameter of the capillaries 260. In this way, the spacer plate 236 can define a gap between the central portion 264 and the slit plate 234. Thus, the slit plate 234, when coupled to the spacer plate 236, can contact the edge portions 266 of the spacer plate, rather than the capillaries 260, which can reduce or eliminate forces on the capillaries 260. Once the slit plate 234 is coupled to the spacer plate 236, the ability of the capillaries to move perpendicular to the central portion 264 of the spacer plate 236 can be constrained.

The slit plate 234 can define openings which can provide optical access (i.e., an optical pathway) to the capillaries 260 such that when the capillary cartridge 228 is placed within a detection module (e.g., the detection module 16) the capillaries 260 can be illuminated by a light source through the slit plate 234.

The slits in the slit plate 234 can have a size configured for absorbance and/or florescence. In some embodiments, the spacer plate 236 can define openings that correspond to the slits of the slit plate 238. In such an embodiment, optical access to the capillaries 260 can be provided from both the top and the bottom of the capillary cartridge 228.

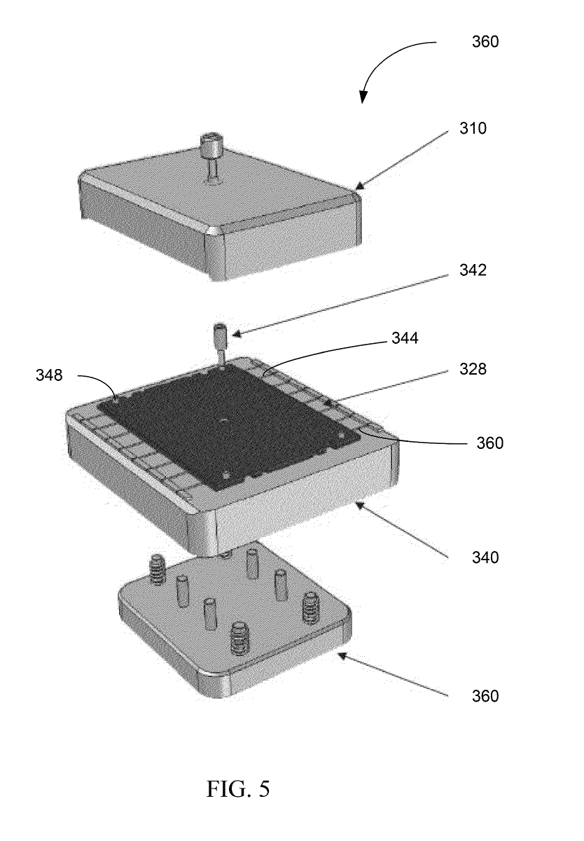

The capillary retention plate 238 can be coupled to the spacer plate 236 opposite the slit plate 234. The spacer plate 236, the slit plate 234 and/or the retention plate 238 can include an adhesive such that once assembled the spacer plate 236, the slit plate 234, and/or the retention plate 238 can be adhered together. In addition, the slit plate 234, the spacer plate 236, and/or the retention plate 238 can define glue holes 270 through which adhesive can flow. In this way, adhesive coated on, for example, the spacer plate 264 can flow through glue holes 270 to adhere the spacer plate 264 to the top structural plate 232 and/or the bottom structural plate 234. In some embodiments, the top structural plate 232 and/or the bottom structural plate 240 are devoid of glue holes 270. In other embodiments, the top structural plate 232 and/or the bottom structural plate 240 can include glue holes 270. As described in further detail herein with reference to FIG. 5, in some embodiments the top structural plate 232, the spacer plate 236, the slit plate 234 the retention plate 238, and/or the bottom structural plate 240 can each include alignment holes configured to receive projections from an assembly plate during assembly. Alignment holes can be distinct from the glue holes 270. In some embodiments, the retention plate 238, the spacer plate 236, and/or the slit plate 234 can be coated with parylene, which can reduce or eliminate the potential for electrical shorting across the cartridge 228 during separation (e.g., between analyte and catholyte pools). In some embodiments, the top structural plate 232, the spacer plate 236, the slit plate 234, the retention plate 238, and/or the bottom structural plate 240 can be constructed of a conductive material, such as metal, for cost and accuracy reasons, which can increase the risk of an electrical short. Parylene, and/or any other suitable insulator can be vapor deposited (or applied by any other suitable means) onto the top structural plate 232, the spacer plate 236, the slit plate 234, the retention plate 238, and/or the bottom structural plate 240 which can prevent or reduce arcing. In other embodiments, an insulative base can be provided for the cartridge 228, for example below and/or around the bottom structural member 240 and/or in place of the bottom structural member 240.

In some embodiments, the top structural plate 232 and/or the bottom structural plate 240 are more rigid than the slit plate 234, the spacer plate 236, and/or the retention plate 238. In such an embodiment, the top structural plate 232 and the bottom structural plate 240 can resist bending and/or twisting which could compromise the capillaries 260. In some embodiments, the top structural plate 232 and/or the bottom structural plate 240 (alone or in combination) can be thicker than the slit plate 234, the spacer plate 236, and/or the retention plate 238 (alone or in combination), which can enable the flatness of the cartridge 228 to be improved, for example, by providing additional material that can be milled, polished, or planed to flat surface. In some embodiments, the cartridge 228 can be configured such that a force applied to the top structural plate 232 and/or the bottom structural plate 240 is transmitted through the edge portions 266 of the spacer plate 236 and not the capillaries 260. In some embodiments, the top structural plate 232 and/or the bottom structural plate 240 define openings or slits corresponding with and/or similar to the slits of the slit plate 234. In some embodiments, the top structural plate 232, the spacer plate 236, the retention plate 238, and/or the bottom structural plate 240 can each define slits wider than the slits of the slit plate 234. In such an embodiment, the top structural plate 232, the spacer plate 236, the retention plate 238, and/or the bottom structural plate 240 may be less precisely aligned (e.g., to the capillaries 260) than the slit plate 234. In other embodiments, the top structural plate 232 and/or the bottom structural plate 240 can define an aperture providing optical access to multiple capillaries 260.

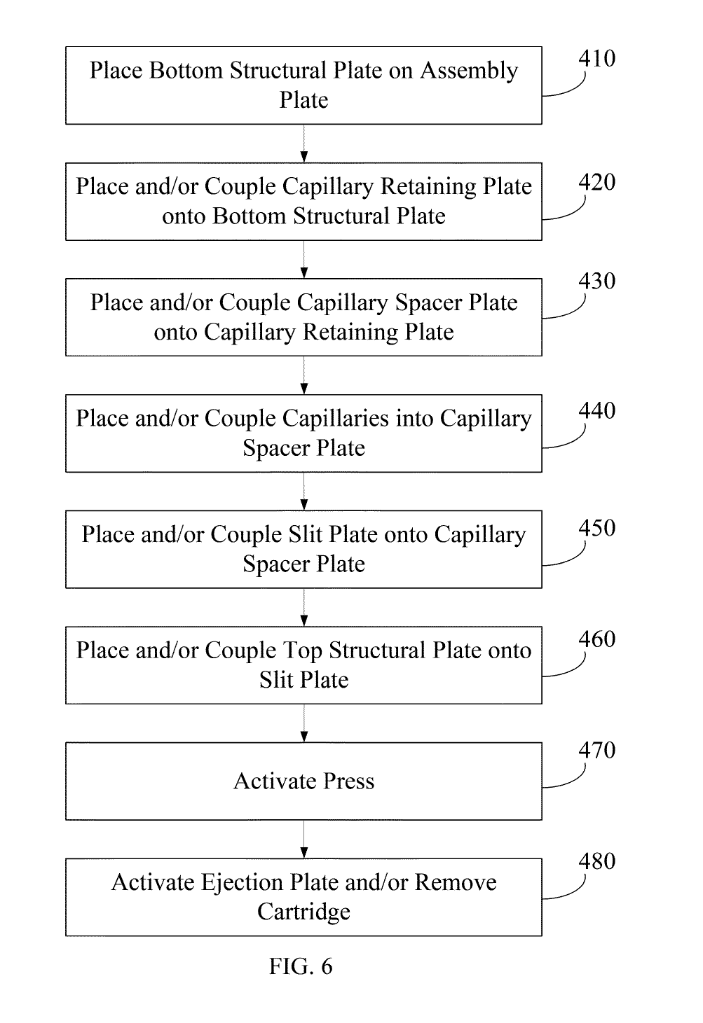

FIG. 5 is an exploded view of a jig 300 for assembling a capillary cartridge 328, according to an embodiment. The capillary cartridge 328 can be structurally and/or functionally similar to the capillary cartridges 28, 128, and/or 228 as shown and described above with reference to FIGS. 1, 2C, 2D, 3, and/or 4. For example, the capillary cartridge 328 can include a top structural plate, a slit plate, a spacer plate, a retention plate, a bottom structural plate, and/or capillaries (referred to as components of the capillary cartridge 328). The jig 300 includes a top clamp 310, a retaining clamp 342, an assembly plate 340, and an ejection plate 360. FIG. 6, which is described in parallel with FIG. 5, is a flow chart of a method for assembling a capillary cartridge, according to an embodiment.

The capillary cartridge 328 can be assembled on the assembly plate 340. For example, a bottom structural plate can be placed on the assembly plate 340, at 410. A capillary retention plate can then be placed on top of and/or coupled to the bottom structural plate, at 420. Similarly, a capillary spacer plate can be placed on top of and/or coupled to the capillary retention plate, at 430. Capillaries 360 can then be placed into and/or on the assembly plate 340, at 440. For example, capillaries 360 can be positioned in capillary receiving portions of the capillary spacer plate (e.g., the capillary receiving portions 262 as shown and described above with reference to FIGS. 3 and 4) such that the capillary spacer plate fixes the position of each capillary 360 relative to each other capillary 360. In some embodiments, the assembly plate 340 can define locating grooves 344. The locating grooves 344 can accept and/or retain the capillaries 360 while the cartridge 328 is being assembled. The locating grooves 344 can have a length similar to the length of the capillaries. For example, an operator assembling the capillary cartridge 328 can select or cut capillaries to match the length of the locating grooves 344 and/or the locating grooves 344 can exclude capillaries having a length greater then the length of the locating grooves. In some embodiments the locating grooves 344 can cooperate with capillary receiving portions of a spacer plate of the cartridge 328 to, for example, position the capillaries in an appropriate location relative to the capillary spacer plate.

After placing the capillaries 360 on the assembly plate 340, a slit plate can be placed on top of and/or coupled to the capillary spacer plate, at 450 and/or a top structural plate can be placed on top of and/or coupled to the spacer plate, at 460.

A retaining clamp 342 can apply a force to the cartridge 328 during assembly to reduce or prevent components of the cartridge 328 from moving relative to each other. In addition or alternatively, projections 348 from the assembly plate 340 can be received by retention holes defined by components of the cartridge 328, which can reduce or prevent components of the cartridge 328 from moving relative to each other. In some embodiments, the assembly plate 340 can include slots operable to allow microscopic inspection of the cartridge 328 during assembly.

Once the cartridge 328 is assembled, the top clamp 310 can be brought into contact with the cartridge 328 and/or the assembly plate 340, at 470. In some embodiments, pressure can be applied to the top plate 310, for example, using press and/or lever, which can fix the position of the components of the cartridge 328 relative to each other. Once the position of the components of the cartridge are fixed, an adhesive can be activated to couple the components to each other. For example, in an embodiment where one or more of the components of the cartridge 328 includes a heat-activated adhesive, the top clamp 310 can be heated, which can activate the adhesive. In other embodiments, a press and/or lever can cause the components of the cartridge 328 to become coupled, for example, by press- or snap-fitting the components together.

After applying a pressure to the cartridge 328, the top clamp 310 and/or the retaining clamp 342 can be removed. The ejection plate 360 can be activated, at 480, which can free the cartridge 328 from the assembly plate 340. In some embodiments, the ejection plate 360 can be operable to cause the cartridge to be ejected perpendicular to the assembly plate 340. The cartridge 328 can be removed, and the jig 360 can be ready to assemble a new cartridge.

While various embodiments have been described above, it should be understood that they have been presented by way of example only, and not limitation. Furthermore, although various embodiments have been described as having particular features and/or combinations of components, other embodiments are possible having a combination of any features and/or components from any of embodiments where appropriate as well as additional features and/or components. For example, although some embodiments describe a capillary cartridge having two structural plates, a retention plate, a capillary spacer plate, and a slit plate, other embodiments can have fewer components. For example, in one embodiment, a single plate can perform the function of the retention plate and the spacer plate. In another embodiment, the slit plate and/or the retention plate can perform the function of a structural plate. Similarly stated, in some embodiments, components of capillary cartridges can perform multiple functions.

Where methods described above indicate certain events occurring in certain order, the ordering of certain events may be modified. Additionally, certain of the events may be performed repeatedly, concurrently in a parallel process when possible, as well as performed sequentially as described above.

What is claimed is:

1. An apparatus comprising:
a plurality of capillaries;
a capillary spacer plate defining a plurality of capillary receiving portions configured to receive the plurality of capillaries and fix the relative position of the plurality of capillaries such that the plurality of capillaries can be used without moving a first capillary of the plurality of capillaries relative to a second capillary of the plurality of capillaries after the plurality of capillaries are fixed by the capillary spacer plate; and
a slit plate configured to be coupled to the capillary spacer plate, the slit plate defining a plurality of slits configured to provide optical access to the plurality of capillaries such that optical measurements associated with the plurality of capillaries can be made when the plurality of capillaries are fixed between the slit plate and the spacer plate.

2. The apparatus of claim 1, wherein the capillary spacer plate includes:
a planar portion, an axis of each capillary of the plurality of capillaries parallel to the planar portion; and
a folded portion including the capillary receiving portions, a portion of the folded portion intersecting the axes of the plurality of capillaries, the folded portion configured such that the slit plate does not directly contact the planar portion of the capillary spacer plate when the slit plate is coupled to the capillary spacer plate.

3. The apparatus of claim 1, further comprising:
a first structural plate defining an opening configured to provide optical access to at least one capillary from the plurality of capillaries; and
a second structural plate, the capillary spacer plate, the plurality of capillaries, and the slit plate configured to be disposed between the first structural plate and the second structural plate.

4. The apparatus of claim 1, further comprising a structural plate,
the plurality of capillaries and the slit plate configured to be disposed between the capillary spacer plate and the structural plate,
the plurality of capillaries, the slit plate, and the structural plate configured to be collectively used in connection with capillary electrophoresis such that, when used in connection with capillary electrophoresis, a sample passes through at least one capillary from the plurality of capillaries and an optical measurement of the sample within the capillary is made while the at least one capillary is disposed between the capillary spacer plate and the structural plate.

5. The apparatus of claim 1, wherein the plurality of capillaries are configured to have at least one sample flow through the plurality of capillaries in parallel.

6. The apparatus of claim 1, wherein the slit plate is adhered to the capillary spacer plate.

7. The apparatus of claim 1, wherein a first side of the slit plate is configured to be coupled to the capillary spacer plate, the apparatus further comprising:
a structural plate configured to be coupled to a second side of the slit plate, the structural plate and the capillary spacer plate each defining openings such that optical access to the capillaries is provided from both the first side and the second side of the slit plate.

8. The apparatus of claim 1, further comprising a capillary holder,
the plurality of capillaries, the capillary spacer plate, and the slit plate configured to be collectively disposed within the capillary holder, the capillary holder defining a sample well, an end portion of at least one capillary from the plurality of capillaries configured to be disposed in the sample well when the plurality of capillaries are disposed within the capillary holder.

9. The apparatus of claim 1, wherein a first end and a second end of each capillary of the plurality of capillaries extends beyond the slit plate.

10. The apparatus of claim 1, wherein a first end and a second end of each capillary of the plurality of capillaries extends beyond the slit plate and the capillary spacer plate.

11. A method comprising:
disposing a plurality of capillaries within a capillary spacer plate such that a first portion of each capillary of the plurality of capillaries is disposed within a first capillary receiving portion of the capillary spacer plate and a second portion of each capillary of the plurality of capillaries is disposed within a second capillary receiving portion of the capillary spacer plate, a radial position of each capillary fixed relative to each other capillary when the plurality of capillaries are disposed on the capillary spacer plate; and
coupling a slit plate to the capillary spacer plate, the slit plate defining a plurality of openings, each opening of the plurality of openings providing optical access to a capillary of the plurality of capillaries such that the spacer plate, the slit plate, and the plurality of capillaries configured to collectively be moved to an electrophoretic cell configured to induce electroosmotic flow through the plurality of capillaries such that an optical measurement of a capillary of the plurality of capillaries can be made without moving the capillary relative to any other capillary from the plurality of capillaries.

12. The method of claim 11, wherein a first side of the slit plate is configured to be coupled to the capillary spacer plate, the method further comprising:
coupling a plate to a second side of the slit plate, the plate and the capillary spacer plate each defining openings such that optical access to a capillary of the plurality of capillaries is provided from both the first side and the second side of the slit plate.

13. The method of claim 11, wherein the slit plate is configured to be coupled to a first side of the capillary spacer plate, the method further comprising:
coupling a first plate to the slit plate; and
coupling a second plate to a second side of the capillary spacer plate, the first plate and the second plate each defining openings such that a beam of light can pass through the first plate, the slit plate, a capillary of the plurality of capillaries, and the second plate.

14. The method of claim 11, further comprising:
positioning the capillary spacer plate on an assembly jig, the capillary spacer plate including an adhesive, the slit plate defining an adhesive opening configured to allow the adhesive to flow therethrough;
placing a plate on top of the slit plate; and
activating the adhesive such that the capillary spacer plate adheres to the slit plate and the adhesive flows through the adhesive opening of the slit plate to cause the plate to adhere to the slit plate.

15. The method of claim 11, further comprising:
positioning the capillary spacer plate on an assembly jig, at least one of the capillary spacer plate or the slit plate including an adhesive, the jig including capillary guides such that the disposing the plurality of capillaries on the capillary spacer plate includes placing capillaries within the capillary guides;
placing a plate on top of the slit plate;
activating the adhesive; and
ejecting the capillary spacer plate, the plurality of capillaries, the slit plate, and the plate from the assembly jig using an ejection plate.

16. The method of claim 11, further comprising:
positioning the capillary spacer plate on an assembly jig, at least one of the capillary spacer plate or the slit plate including an adhesive, the jig including capillary guides such that the disposing the plurality of capillaries on the capillary spacer plate includes placing capillaries within the capillary guides;
microscopically inspecting at least one capillary of the plurality of capillaries;
placing a plate on top of the slit plate; and
activating the adhesive.

17. A system comprising:
a capillary electrophoresis analyzer including a capillary holder having a sample reservoir and an electrode;
a capillary cartridge configured to be disposed within the capillary holder,
the capillary cartridge including a plurality of capillaries, each capillary of the plurality of capillaries fixed relative to each other capillary of the plurality of capillaries and
the capillary cartridge defining a plurality of optical pathways, each optical pathway of the plurality of optical pathways including a portion of a capillary of the plurality of capillaries and defined in part by a slit defined by a slit plate; and
an optical sensor configured to detect light transiting each of the plurality of optical pathways.

18. The system of claim 17, wherein the automated capillary electrophoresis analyzer is a capillary isoelectric focusing analyzer.

19. The system of claim 17, wherein the capillary holder is configured to receive a loose capillary or the capillary cartridge.

20. The system of claim 17 wherein a portion of each capillary of the plurality of capillaries extends into the sample reservoir when the capillary cartridge is disposed within the capillary holder.
